(19) United States
(12) Patent Application Publication
(10) Pub. No.: US 2025/0149949 A1
(43) Pub. Date: May 8, 2025

(54) BRUSHLESS MOTOR AND METHOD FOR ASSEMBLING A BRUSHLESS MOTOR

(71) Applicant: Abiomed Europe GmbH, Aachen (DE)

(72) Inventors: Christian MUNDLE, Schönaich (DE); Frank BURKHARDT, Schönaich (DE); Herbert WALLNER, Schönaich (DE)

(73) Assignee: Abiomed Europe GmbH, Aachen (DE)

(21) Appl. No.: 18/838,435

(22) PCT Filed: Feb. 15, 2023
(86) PCT No.: PCT/EP2023/053746

§ 371 Date: Aug. 14, 2024

(30) Foreign Application Priority Data
Feb. 22, 2022 (DE) 10 2022 201 849.4

(51) Int. Cl. H02K 5/128; F04D 13/06; F16C 41/00; H02K 7/08; H02K 15/14; H02K 21/14

(52) U.S. Cl. CPC H02K 5/128; F04D 13/06; F16C 41/005; H02K 7/083; H02K 15/14; H02K 21/14

(57) ABSTRACT

The present invention relates to a brushless motor (1), in particular as a drive for a pump for conveying a fluid, having at least one housing (2), at least one stator (3) and at least one rotor (4), wherein a fluid can flow through the housing (2) at least in a gap (5) between the stator (3) and rotor (4) in the housing (2), wherein the stator (3) is formed in a fluid-tight stator chamber (6), and wherein the rotor (4) is formed in a fluid-tight manner.

A compact motor (1), which ensures high requirements for sealing against ambient media, is realized in that the stator chamber (6) is limited in the direction of the rotor (4) by at least one inner sleeve (8), and in that at least one rotor bearing element (9) for mounting the rotor (4) is supported on an inner circumference (10) of the inner sleeve (8).

The invention relates to a brushless motor, in particular as a drive for at least one impeller for conveying a fluid. The motor comprises at least one housing, at least one stator and at least one rotor. A fluid can flow through the housing at least in a gap between the stator and the rotor. The housing has corresponding openings on the end sides for this purpose. The rotor is fluid-tight and the stator is disposed in a fluid-tight stator chamber.

Brushless motors, in particular brushless DC motors, are known in the state of the art in a variety of configurations. Such motors, particularly in small format, are used, for example, as drives for pumps to convey fluids, such as fuels, in the food industry or in medical technology.

DE 299 21 352 U1, for example, discloses an intravascular blood pump with an electric motor. At a first end of the electric motor, an impeller is disposed on the motor shaft to convey the fluid. The stator windings are embedded in a synthetic resin matrix. The vane-less rotor is mounted on a rotor shaft and protected against contact with the fluid by seals.

DE 10 2010 005 963 A1 discloses a brushless electric motor as a rotary drive for a fuel pump. The rotor has a metal sleeve that hermetically seals the rotor.

Particularly when using such motors in medical technology, there are many challenges with regard to the compactness of the motors and sealing against fluids.

The motors known from the state of the art are often unable to meet the increased requirements for a compact design with high performance and efficiency.

The present invention is based on the task of providing a brushless motor which is particularly compact with high performance and ensures increased requirements for sealing against fluids.

The aforementioned task is solved in such a motor according to the characterizing portion of claim 1 in that the stator chamber is limited in the direction of the rotor by at least one inner sleeve, and in that at least one rotor bearing element for mounting the rotor is supported on an inner circumference of the inner sleeve.

The housing of the motor is preferably configured in such a way that a fluid, for example a flushing fluid, can flow axially through it between a first end face and a second end face. The flow through the housing essentially takes place in the gap formed between the stator and the rotor, in particular the annular gap. The gap between the stator and rotor is limited by the inner sleeve over the entire length of the stator in the radial direction. The inner sleeve is preferably configured in such a way that it radially limits the entire fluid path within the housing, in particular between a motor flange disposed at a first end and a flushing connection disposed at a second end. The inner sleeve is part of the housing and limits the gap in the direction of the stator chamber surrounding the rotor. The inner sleeve surrounds a rotor chamber in which the rotor is rotatably disposed, in particular mounted.

The stator surrounds the rotor, which can be rotated about a motor axis A within a rotor chamber.

The motor preferably has control electronics and/or power electronics that are at least partially disposed in the housing. The control electronics and/or power electronics have at least one circuit board that is disposed, in particular encapsulated, inside the housing. The circuit board can preferably be contacted via at least one, preferably at least two or at least three, connection line(s) out of the housing.

In particular to ensure a compact configuration of the motor, at least one rotor bearing element is provided for mounting the rotor, in particular inside the inner sleeve. The rotor bearing element is disposed in such a way that it is supported on an inner circumference of the inner sleeve. Preferably, at least two rotor bearing elements are provided for mounting the rotor, with both rotor bearing elements being supported on a circumference of the inner sleeve. In particular, both rotor bearing elements are disposed inside the inner sleeve. At least one rotor bearing element is configured, for example, as a ball bearing, magnetic bearing, ceramic bearing or plain bearing. Preferably, at least one rotor bearing element has hydrodynamic lubrication and is configured in particular as a ceramic bearing. Preferably, both rotor bearing elements are configured identically.

In particular, at least one rotor bearing element is mounted with a sliding fit in the inner sleeve, preferably both rotor bearing elements are mounted with a sliding fit in the inner sleeve. Alternatively, it is provided that at least one rotor bearing, preferably both rotor bearings, are connected, in particular glued, to the inner sleeve.

Very low friction in the rotor bearings can be achieved by preloading the rotor with a very low preload force in one direction, in particular with at least one wave spring washer. For example, the preload force is exactly or less than 5 N, in particular exactly or less than 3 N.

Preferably, at least part of the bearing cage, preferably the entire bearing cage, is made of a biocompatible plastic material, in particular polyether ether ketone (PEEK). The arrangement of the rotor bearing element within the inner sleeve has the advantage that no additional installation space is required for the rotor bearing element, which ensures a compact design.

Compared to the prior art, the invention has the advantage that the inner sleeve in particular achieves high safety requirements with regard to fluids while at the same time making the motor compact. The at least partial flow of a fluid through the housing during operation ensures advantageous heat dissipation, which, for example, prevents high temperatures of the housing on the outside. The motor is configured very efficiently to prevent excessive heating of the fluid.

According to a first embodiment of the motor, it has proven to be advantageous if it is provided that the rotor bearing element or the rotor bearing elements is/are configured and arranged so that the fluid can flow around and/or through them. Consequently, the rotor bearing element or the rotor bearing elements are arranged in such a way that a fluid flowing in the gap between the stator and the rotor at least flows around and/or through them. It is particularly advantageous that the rotor bearing elements, for example in the form of ball bearings, are at least partially made of plastic. Preferably, the cage is made of a plastic, in particular polyether ether ketone (PEEK). For example, balls are made of ceramic and bearing rings—inner ring and/or outer ring—are made of corrosion-resistant steel.

A further preferable configuration of the motor is that the inner sleeve is formed in one piece. Preferably, the inner sleeve extends in one piece from the motor flange on a first end side to the opposite, second end side of the motor. In order to ensure biocompatibility of the motor, particularly in medical applications, it is intended that the inner sleeve is made of a biocompatible plastic. In particular, polyether ether ketone (PEEK) or polytetrafluoroethylene (PTFE) have proven to be suitable biocompatible plastics. It is also provided that the inner sleeve is made up of several parts, in particular two parts, and that the parts of the inner sleeve are joined together in a materially bonded, in particular fluid-tight, manner, preferably glued or welded.

The inner sleeve is preferably configured in such a way that it delimits a rotor chamber within the housing in a radial direction. The motor flange is preferably formed on a first end side, which axially delimits the rotor chamber and allows fluid to escape from the housing, in particular from the rotor chamber. On a second end side, the rotor chamber is preferably axially limited by a flushing connection, through which the fluid can enter the gap between the rotor and stator. The second end side of the motor or housing is sealed with a potting compound, in particular a low-stress curing potting compound

The configuration of the inner sleeve has an influence on the efficiency of the motor and the size of the motor. According to a further embodiment, it is therefore provided in particular that the inner sleeve has a wall thickness of between 0.075 mm and 1 mm at least in the area between the rotor and stator, in particular along the length of the stator. A wall thickness of between 0.1 mm and 0.5 mm is particularly preferred. The inner sleeve preferably has a constant wall thickness at least along the length of the stator windings. Such small wall thicknesses pose a challenge for assembly, which is why a method for assembling a motor described below is also claimed according to the invention.

Among other things, the inner sleeve delimits the rotor chamber. According to a further embodiment of the motor, at least one outer sleeve is provided on the outside of the housing. The outer sleeve delimits the housing, in particular the stator chamber, on the outside in a radial direction. The housing is configured in such a way that the inner sleeve delimits the stator chamber in the direction of the internal rotor chamber. In the radial direction, the outer sleeve also delimits the housing along its entire circumference. A wall thickness of 0.05 mm and 1 mm, in particular between 0.1 mm and 0.5 mm, has proven to be particularly advantageous for the outer sleeve. Preferably, the outer sleeve is made of a corrosion-resistant steel.

According to a further embodiment, it has also been found to be preferable if a motor flange is disposed on at least one first end side of the motor. The motor flange preferably supports the inner sleeve and the outer sleeve, so that the stator chamber between the inner sleeve and the outer sleeve is formed as an annular space. Preferably, the motor flange is bonded or welded to the outer sleeve. Laser welding between the outer sleeve and the motor flange is particularly preferred. For example, the motor flange is made of the same material as the outer sleeve.

The motor flange preferably has a central recess that provides an opening to the rotor chamber to ensure the flow of fluid. The motor flange also has at least one central thread. The motor can be attached to the thread or the thread serves as an interface for attaching other components to the motor. The motor flange is preferably penetrated by at least one motor shaft portion of the rotor. The motor shaft portion is configured to drive, for example, a shaft that can be coupled to the motor shaft portion. For example, the motor shaft portion has structures that are configured to interact in a positive fit, in particular to transmit a torque, with a connectable shaft. At least in the operating state of the motor, the motor shaft portion is rotatable.

According to a further embodiment of the motor, it is provided that the inner sleeve has at least one flange portion on the first end side, which in particular coats a central recess of the motor flange on the inside. The flange portion is preferably pressed into the recess in the motor flange. The wall thickness in the area of the flange portion is preferably increased, in particular at least doubled, compared to the wall thickness in the area between the rotor and the stator. Furthermore, at least one portion with a reduced diameter is also provided in the flange portion of the inner sleeve, so that at least one abutment edge is provided for a rotor bearing element and/or a mounting ring. The mounting ring is made of polyether ether ketone (PEEK), for example.

Preferably, a collar-like extension is formed between the flange portion and the portion of the inner sleeve with constant wall thickness that extends between the rotor and stator, which preferably extends in the direction of the outer sleeve of the motor. For example, the collar-like extension is disposed in such a way that it rests against the motor flange, in particular on the end face. The collar-like extension is used in particular for electrical insulation from the motor flange and for the axial positioning of the coils and the iron return.

Opposite the first end of the motor, the housing, in particular the stator chamber, is sealed with at least one potting compound, for example. In particular, the potting compound is penetrated by at least one connection line for the motor and/or by a flushing connection. The flushing connection is preferably made of the same material as the outer sleeve. The potting compound preferably fills both the annular space between the outer sleeve and the inner sleeve as well as the end area of the inner sleeve. Low-stress curing potting compounds have proven to be particularly advantageous. For example, the outer sleeve extends from the second end side to the end of the housing, with the inner sleeve inside the potting compound having a slight distance to the end of the housing.

The advantage of using the potting compound is that heat is dissipated and the inner sleeve is supported and stabilized.

According to a further embodiment of the motor, it is also provided in particular that at least one centering flange is disposed on the second end side, which positions the inner sleeve and the outer sleeve at a distance from one another. Preferably, the centering flange also serves as a limiting element for the potting compound. Furthermore, it is preferably provided that the stator chamber, in particular the cavities present in the stator chamber, are potted with at least a second potting compound, preferably a low-stress curing potting compound, in particular up to the centering flange. Preferably, the centering flange has at least one penetration for the introduction of potting compound.

The motor, in particular the stator chamber, is thus advantageously redundantly sealed against ambient media, on the first end side by the motor flange and the potting compound in the stator chamber, and on the second end side by the external potting compound and the second potting compound in the stator chamber.

The flushing connection in the second end area of the housing has at least one connection contour outside the housing, for example for a hose. The connection contour is configured, for example, as a mandrel profile. The flushing connection is used to pass fluid, for example a flushing fluid, through the potting compound into the housing of the motor, in particular from the inner circumference of the inner sleeve, so that the fluid can flush around the rotor and flow in an axial direction in the gap between the rotor and stator. Preferably, the outer diameter of the flushing connection in the area of the inner sleeve has a diameter that matches the inner diameter of the inner sleeve. The flushing connection preferably has a sliding fit relative to the inner circumference of the inner sleeve.

In the area of the second end side of the motor, at least one, for example ring-shaped, circuit board with control electronics and/or power electronics for the motor is preferably disposed in the housing, in particular in the stator chamber. Preferably, the circuit board is held by a circuit board carrier extending in a ring around the outer circumference of the inner sleeve.

The rotor is preferably mounted completely within the inner sleeve. According to a further embodiment of the motor, it has also been found to be advantageous if the rotor has at least one rotor sleeve and that the rotor sleeve has a first shaft extension on a first end side and a second shaft extension on a second end side. Preferably, the rotor is mounted on the shaft extensions of the rotor sleeve.

At least one permanent magnet of the rotor, in particular a plurality of permanent magnets, is disposed inside the rotor sleeve. The at least one permanent magnet is disposed in the rotor sleeve, between the first shaft extension and the second shaft extension. Preferably, the permanent magnet is configured as a full cylinder magnet, in particular as a neodymium-iron-boron magnet.

For example, the rotor sleeve is made of the same material as the outer sleeve of the motor. The first shaft extension and the second shaft extension are also made of this material, for example. For example, the first shaft extension and/or the second shaft extension are welded to the rotor sleeve, in particular by laser welding.

The first shaft extension on a first end side of the motor protrudes at least partially into the rotor sleeve and is preferably sealed on the inside with a plug, in particular a plug made of polyether ether ketone (PEEK), in order to prevent the ingression of fluid. The first shaft extension also has a motor shaft portion on which, for example, the first bearing element is arranged. In particular, the motor shaft portion exits the housing through the motor flange, for example to drive a shaft that can be connected to the motor shaft portion. For example, the connectable shaft is at least partially inserted into the motor shaft portion for connection. In particular, the motor shaft portion represents an interface for transmitting a torque. The motor shaft portion has, for example, at least partially a profiled outer contour or inner contour, in particular an outer square and/or an inner square.

The second shaft extension on a second end side of the housing also penetrates at least partially into the rotor sleeve and is preferably welded to it. At the end of the second shaft extension oriented towards the second end area, the diameter is reduced in such a way that it corresponds to the inside diameter of the rotor bearing element disposed there. Preferably, the inner diameter of both rotor bearing elements is essentially identical. In addition, a spring washer, in particular a wave spring washer, is disposed on the second shaft extension, which is preferably supported against the flushing connection in order to support the rotor in the axial direction with a sliding fit. The rotor is preferably preloaded by the spring washer, in particular preloaded with a preload force of equal to or less than 5 N, preferably equal to or less than 3 N. The preload is preferably applied in the direction of the first end side of the motor. Preferably, the rotor sleeve is connected to the shaft extensions in a fluid-tight manner.

A further embodiment of the motor provides for the first shaft extension to have at least one motor shaft portion on the first end side. The motor shaft portion is at least partially hollow so that a fluid can flow through it. The motor shaft portion has an axially extending recess. The motor shaft portion is formed in one piece with the first shaft extension, for example. Alternatively, it is also provided that the motor shaft portion is attached to the shaft extension. It is also provided that a first motor shaft portion, preferably without a recess, is disposed on the first shaft extension, and that a second motor shaft portion, in particular as an adapter, can be attached to the first motor shaft portion, wherein the second motor shaft portion has a longitudinally extending recess, preferably with an internal square.

In order to further increase the efficiency of the motor, a further embodiment provides for the stator to have an iron return with a large number of individual sheets disposed next to each other. The iron return is disposed between the windings of the stator and the outer sleeve. The individual sheets are made of silicon iron or nickel sheet metal, for example. The individual sheets of the iron return preferably have a thickness of between 0.05 mm and 0.5 mm. A thickness of between 0.05 mm and 0.3 mm is also preferred. A thickness of approximately 0.1 mm or 0.2 mm for each of the individual sheets is particularly preferred.

Furthermore, it has been found to be advantageous in terms of efficiency if the stator is provided with at least three or at least four pairs of coils. The coils are wound without iron, preferably according to the bell-shaped armature principle. Preferably, two pairs of coils, in particular pairs of coils disposed substantially opposite each other, are connected in series so that, for example, only six winding taps are present in the case of six coils. In particular, the coils are interconnected on the circuit board.

The dimensioning of the gap between the inner sleeve and the rotor has a strong influence on the efficiency of the motor and the fluid losses. According to a further configuration of the motor, it has therefore proved advantageous if it is provided that the gap between the rotor and stator has a height of between 0.12 mm and 1.5 mm over at least 50% of the length of the rotor. For example, the gap between the rotor and stator has the aforementioned height at least over the entire length of the rotor sleeve. A height of the gap between 0.25 mm and 1 mm is particularly preferred, and a height of the gap of approximately 0.5 mm is even more preferred.

Furthermore, the efficiency of the motor according to a further embodiment can be influenced by the ratio of the outer diameter of the inner sleeve to the outer diameter of the housing being between 0.3 and 0.7. A ratio of 0.5 is particularly preferred. It is also provided, for example, that the ratio of the outer diameter of the winding of the stator to the outer diameter of the iron return is between 0.6 and 0.9, in particular around 0.8.

The invention also relates to a method for assembling a motor, in particular according to one of the above embodiments, comprising at least the following method steps:
Providing a motor flange with an outer sleeve disposed thereon to delimit the housing of the motor and an inner sleeve disposed on the motor flange, in particular wherein a flange portion of the inner sleeve enters the motor flange,
at least partial filling of the stator chamber between the inner sleeve and outer sleeve with a first potting compound,
disposing the stator windings and the iron return in the stator chamber, in particular on an outer circumference of an inner sleeve, in the, in particular not yet solidified, first potting compound,
inserting the rotor together with the rotor bearing element into a rotor chamber formed by the inner sleeve, so that a motor shaft portion of the rotor protrudes from the housing in the area of the motor flange,
disposing a flushing flange, in particular at least partially in the inner sleeve, and at least one centering flange, in particular between the inner sleeve and the outer sleeve,
potting the housing on the second end side with a second potting compound.

The installation sequence described above warrants that even inner sleeves with very thin walls can be installed easily.

In particular, it is intended that any cavities remaining in the stator chamber after the stator windings and the iron return have been inserted, in particular up to the centering flange, are filled with potting compound. Preferably, at least one spring washer, in particular a wave spring washer, is disposed on the second shaft extension before the flushing flange is disposed. In particular, it is provided that the rotor is preloaded via the flushing flange in the direction of the first end side, that the potting compound is then introduced, and that the preload is released after the potting compound has hardened, so that the rotor remains preloaded between the flushing flange and the first end side.

Further preferable embodiments of the invention are shown in the following description of the figures and the dependent subclaims.

It shows:

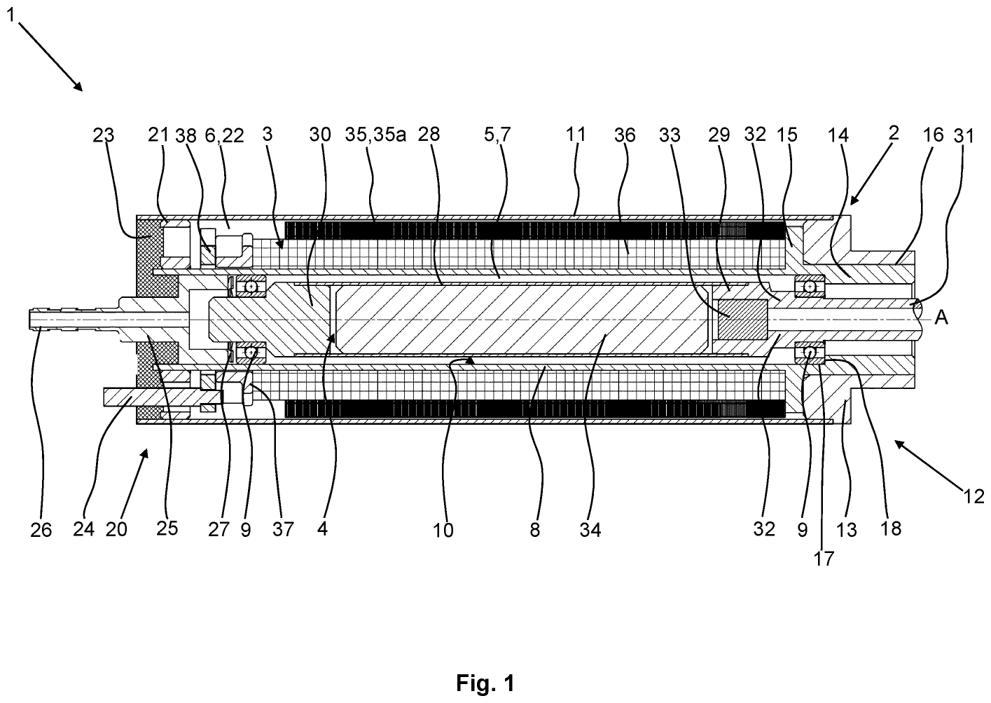

FIG. 1 a sectional side view of an embodiment of a brushless motor according to the invention, and

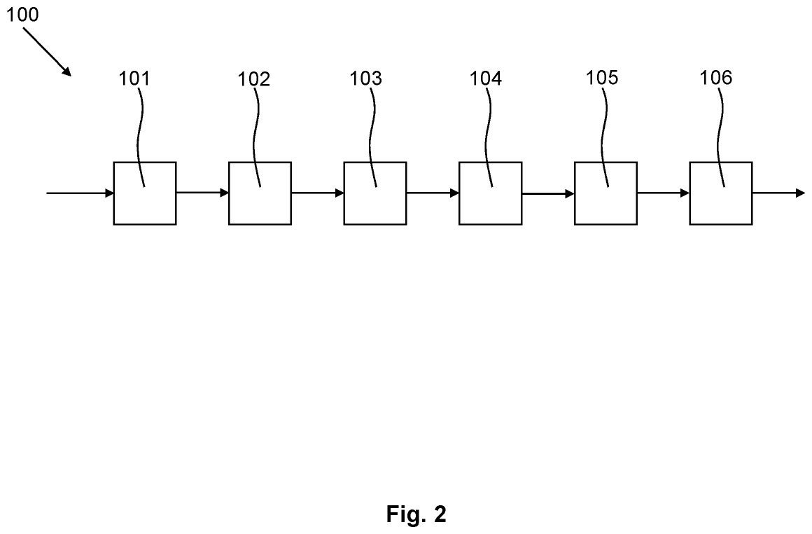

FIG. 2 an example of a schematic sequence of a method according to the invention.

In the various figures in the drawing, identical parts are always marked with the same reference symbols.

With regard to the following description, it is claimed that the invention is not limited to the exemplary embodiments and thereby not limited to all or several features of described feature combinations, rather each individual partial feature of the/each exemplary embodiment is also of significance for the object of the invention independently of all other partial features described in connection therewith, and also in combination with any features of another exemplary embodiment.

FIG. 1 shows an exemplary embodiment of a brushless motor 1 in sectional side view. The motor 1 is configured in particular as a drive for a connectable shaft, for example with at least one impeller for conveying a fluid. The motor 1 has at least one housing 2, a stator 3 and a rotor 4. The housing 2 is configured in such a way that a fluid can flow through it in a gap 5, in particular an annular gap, between the stator 3 and rotor 4. For this purpose, the stator 3 is formed in a fluid-tight stator chamber 6. The rotor 4 is also fluid-tight and is disposed in a fluid-filled rotor chamber 7 during operation. The gap 5 has a constant height essentially along the extent of the stator 3.

The stator chamber 6 is limited in the direction of the rotor 4, in particular in the radial direction, by an inner sleeve 8. The inner sleeve 8 thus also delimits the outer circumference of the rotor chamber 7. The rotor 4, which is mounted with rotor bearing elements 9, is disposed inside the inner sleeve 8 i.e., in the rotor chamber 7. The rotor 4 can be rotated about a motor axis A running centrally through the housing 2. The rotor bearing elements 9 are configured as ball bearings with a cage made of polyether ether ketone (PEEK). The bearing outer ring of the rotor bearing elements 9 is supported on an inner side 10 of the inner sleeve 8. A sliding fit is formed between the rotor bearing elements 9 and the inner sleeve 8. A fluid flowing in the gap 5 between rotor 4 and stator 3 can flow through the rotor bearing elements 9.

The inner sleeve 8 is made of polyether ether ketone (PEEK) in one piece and delimits the rotor chamber 7 in the radial direction. The inner sleeve 8 delimits the entire space inside the housing 2 in which a fluid can flow through the housing 2 in the axial direction. In the area where the stator 3 extends, the inner sleeve 8 has a constant wall thickness, which is preferably around 0.5 mm. The stator chamber 6 is limited on an outer circumference of the housing 2 by an outer sleeve 11. The outer sleeve 11 is preferably made of a corrosion-resistant steel and has a wall thickness of approximately 0.5 mm.

The inner sleeve 8 and the outer sleeve 11 are supported on a first end face 12 of the motor 1 by a motor flange 13. The outer sleeve 11 is partially pushed onto the motor flange 13 and welded to it by laser welding. The inner sleeve 8 has a flange portion 14 and extends at the first end side 12 with the flange portion 14 into the motor flange 13 and is preferably pressed into the motor flange 13. The flange portion 14 extends in a central recess 16 within the motor flange 13. The inner sleeve 8 extends to the end of the motor flange 13 and is flush with the motor flange 13.

In the axial direction along the motor axis A, the inner sleeve 8 rests against the motor flange 13 on the end face with a collar-like extension 15. On the other side of the collar-like extension 15, the stator 3 is formed in the stator chamber 6. The wall thickness of the inner sleeve 8 in the area of the flange portion 14 is at least twice as large as in the area of the gap 5 between stator 3 and rotor 4. In addition, the flange portion 14 has an area 17 with a reduced diameter in order to ensure a mounting edge 18 within the flange portion 14 for a rotor bearing element 9. The inside diameter in area 17 corresponds to the inside diameter of the inner sleeve 8 in the area between stator 3 and rotor 4.

In this exemplary embodiment, the first rotor bearing element 9 is abuts against the mounting edge 18, so that the first rotor bearing element 9 is supported in the axial direction. On the second end side 20 of the motor 1 or the housing 2, a centering flange 21 is disposed between the outer circumference of the inner sleeve 8 and the inner circumference of the outer sleeve 11. The centering flange 21 keeps the inner sleeve 8 and the outer sleeve 11 at a distance from each other. The centering flange 21 also limits the stator chamber 6 in the axial direction. The stator chamber 6 is completely filled with a first potting compound 22, for example.

At the second end side 20, the housing 2 or the motor 1 is completely sealed by a second potting compound 23. The second potting compound 23 is flush with the outer sleeve 11. The inner sleeve 8 ends at a distance in the potting compound 23. The potting compound 23 is penetrated by an electrical connection cable 24 of the motor 1 and by a flushing connection 25 disposed on the second end face 20. The flushing connection 25 has a connection profile 26 on the outside, for example for a hose. On the inside, the flushing connection 25 serves to introduce the fluid flowing in the gap 5 and is inserted positively into the inner circumference of the inner sleeve 8. The flushing connection 25 is in full contact with the inner side 10 of the inner sleeve 8 and preferably forms a sliding fit with the inner sleeve 8. The direction of flow of a fluid is preferably from the flushing connection 25 to the motor flange 13.

In the axial direction along the motor axis A, a spring washer 27 is disposed between the rotor 4 and the flushing connection 25, which pretensions the rotor 4 in the axial direction towards the first end side 12. The rotor bearing elements 9 are axially movable within the limits of the sliding fit and the spring force of the spring washer 27 and are tensed against each other via the spring force.

The rotor 4 has a rotor sleeve 28, which is attached to a first shaft extension 29 on the first end side 12 and to a second shaft extension 30 on the second end side 20. The rotor sleeve 28 is connected to the shaft extensions 29, 30 in a fluid-tight manner by being welded, in particular laser-welded, to the shaft extensions 29, 30. Material can be applied to the first shaft extension 29 and/or the second shaft extension 30 for balancing the rotor 4 or material can be removed.

The first shaft extension 29 on the first end side 12 of the motor 1 extends at least partially into the rotor sleeve 28. Furthermore, the first shaft extension 29 has a motor shaft portion 31 which protrudes from the housing 2 at the first end side 12, for example in order to interact with a shaft—not shown—and drive the shaft. The motor shaft portion 31 preferably has an internal square—not shown. The motor shaft portion 31 is hollow.

For manufacturing reasons, the bore in the motor shaft portion 31 continues into the area of the rotor sleeve 28 and is closed there with a sealing plug 33, which prevents fluid from entering the rotor 4. A permanent magnet 34 in the form of a full cylinder magnet is disposed between the first shaft extension 29 and the second shaft extension 30 inside the rotor sleeve 28.

The second shaft extension 30 also extends at least partially into the rotor sleeve 28. In the direction of the second end face 20, the second shaft extension 30 has a reduced diameter, so that it can be preferably mounted in the second rotor bearing element 9.

The spring washer 27 exerts a spring force on the rotor 4 in the direction of the first end face 12, so that the rotor 4 is pressed against the mounting edge 18 via the rotor bearing element 9 on the first end face 12.

The stator 3 has an iron return 35 with a large number of individual sheets 35a, which extend side by side in the stator chamber 6. The stator 3 also has an ironless winding 36 with three pairs of coils. The winding 36 extends from the collar-like extension 15 on the first end side 12 to a circuit board carrier 37 on the second end side 20. The circuit board carrier 37 is ring-shaped and supports a circuit board 38, which is also ring-shaped. The circuit board 38 is used here for the electrical connection of the coil pairs of the motor 1.

The gap 5 between rotor 4 and stator 3 is dimensioned such that it has a height of approximately 0.5 mm, at least in the area where the rotor sleeve 28 extends. Such a height of the gap 5 has proven to be particularly advantageous for the efficiency of the motor 1.

FIG. 2 shows an exemplary embodiment of a schematic sequence of a method 100 according to the invention. To assemble the motor 1, the outer sleeve 11 is first applied to the motor flange 13 and welded to it, and the inner sleeve 8 with its flange portion 14 is pressed into the recess 16. The motor flange 13 with the outer sleeve 11 is provided 101. The annular space created between the outer sleeve 11 and the inner sleeve 8—the stator chamber 6—is then filled with a first potting compound 22 102. The stator windings 36 are inserted 104 together with the iron return 35 into the still liquid first potting compound 22. After the centering flange 21 has been inserted, any cavities present in the stator chamber 6 are filled with the first potting compound 22 so that the second potting compound reaches up to the centering flange. Subsequently, the first rotor bearing element 9 together with the pre-assembled rotor 4 is inserted 104 into the rotor chamber 7 in the inner sleeve 8 in such a way that the first rotor bearing element 9 abuts against the mounting edge 18. The rotor bearing elements 9 are supported on the inner side 10 of the inner sleeve 8.

Subsequently, the spring washer 27 is disposed 105 together with the flushing connection 25 in the inner sleeve and a force is applied to the flushing connection 25 in the direction of the first end face 12 so that the rotor 4 is preloaded in the direction of the first end face 12. Finally, potting 106 is carried out with the second potting compound 23 at the second end face 20. The force on the flushing connection 25 is maintained until the second potting compound 23 has completely hardened. Preferably, the stator 3 is pre-assembled until the centering flange 21 is inserted and the first potting compound 22 has hardened, and the rotor 4 including the bearing elements 9 outside a clean room. The assembly of the rotor 4 in the stator 3, including the filling and curing of the second potting compound 23, is preferably carried out in a clean room.

The invention is not limited to the illustrated and described embodiments, but also includes all embodiments having the same effect in the sense of the invention. It is expressly emphasized that the embodiments are not limited to all features in combination; rather, each individual subfeature can also have an inventive significance in its own right independently of all other subfeatures. Furthermore, the invention is not yet limited to the combination of features defined in claim 1, but can also be defined by any other combination of certain features of all the individual features disclosed. This means that, in principle, practically any individual feature of claim 1 can be omitted or replaced by at least one individual feature disclosed elsewhere in the application.

### LIST OF REFERENCE SYMBOLS

1 motor
2 housing
3 stator
4 rotor
5 gap
6 stator chamber
7 rotor room
8 inner sleeve
9 Rotor bearing element
10 inner side of the inner sleeve 8
11 outer sleeve
12 first end side of motor 1
13 motor flange
14 flange portion
15 collar-like extension
16 central recess
17 area of the flange portion 14
18 mounting edge
20 second end side of motor 1
21 centering flange
22 first potting compound
23 second potting compound
24 connecting cable
25 flushing connection
26 connecting profile
27 spring washer
28 rotor sleeve
29 first shaft extension
30 second shaft extension
31 motor shaft portion
33 closing plug
34 permanent magnet
35 iron return
35a individual sheets
36 ironless winding
37 circuit board carrier
38 circuit board

1. A brushless motor, in particular as a drive for a pump for conveying a fluid, having at least one housing, at least one stator and at least one rotor, wherein a fluid can flow through the housing at least in a gap between the stator and rotor in the housing, wherein the stator is formed in a fluid-tight stator chamber, and wherein the rotor is formed in a fluid-tight manner,
characterized in that
the stator chamber is limited in a direction of the rotor by at least one inner sleeve, and in that at least one rotor bearing element for mounting the rotor is supported on an inner circumference of the inner sleeve.

2. A brushless motor according to claim 1,
characterized in that
the rotor bearing element or the rotor bearing elements are configured and arranged so that the fluid can flow around and/or through them.

3. A brushless motor according to claim 1,
characterized in that
the inner sleeve is formed in one piece and/or that the inner sleeve is made of a biocompatible plastic, in particular polyether ether ketone (PEEK) or polytetrafluoroethylene (PTFE).

4. A brushless motor according to claim 1,
characterized in that
at least one outer sleeve is provided, in that the outer sleeve delimits the stator chamber, in particular the housing, on an outside, preferably in that the outer sleeve at least partially has a wall thickness of between 0.05 mm and 1 mm, in particular between 0.1 mm and 0.5 mm.

5. A brushless motor according to claim 4,
characterized in that
a motor flange is disposed on at least one first end side of the brushless motor, and in that the motor flange supports the inner sleeve and the outer sleeve, in particular in that the inner sleeve is at least partially pushed, preferably pressed, into the motor flange.

6. A brushless motor according to claim 5,
characterized in that
the inner sleeve has a flange portion on the first end side, in particular wherein the flange portion extends at least partially into the motor flange.

7. A brushless motor according to claim 6,
characterized in that
the inner sleeve has at least one collar-like extension on the first end side in particular that the collar-like extension rests against the motor flange, preferably on an end face.

8. A brushless motor according claim 7,
characterized in that
at least one centering flange is disposed on a second end side, in that the centering flange positions the inner sleeve and the outer sleeve at a distance from one another, in particular in that the brushless motor, preferably the stator chamber, is sealed at the second end side by at least one potting compound.

9. A brushless motor according to claim 8,
characterized in that
the rotor has at least one rotor sleeve, and in that the at least one rotor sleeve has a first shaft extension on a first end side and a second shaft extension on a second end side, preferably in that the rotor sleeve is connected to the shaft extensions in a fluid-tight manner, in particular in that the rotor bearing elements rotatably mount the rotor on the shaft extensions.

10. A brushless motor according to claim 9,
characterized in that
the rotor has at least one permanent magnet, in particular a plurality of permanent magnets, preferably in that the at least one permanent magnet is disposed in the rotor sleeve and/or is configured as a full cylinder magnet.

11. A brushless motor according to claim 9,
characterized in that
the first shaft extension has a motor shaft portion on the first end side, in particular that the motor shaft portion is at least partially hollow.

12. A brushless motor according to claim 1,
characterized in that
the stator has an iron return with a plurality of individual sheets, in particular in that the individual sheets each have a thickness of between 0.05 mm and 0.5 mm, in particular between 0.05 mm and 0.3 mm, preferably a thickness of approximately 0.1 mm or 0.2 mm.

13. A brushless motor according to claim 1,
characterized in that
the stator has at least three or at least four pairs of coils, preferably that two coils of a pair of coils are connected in series.

14. A brushless motor according to claim 12,
characterized in that
a ratio of an outer diameter of the inner sleeve to an outer diameter of the housing is at least partially between 0.3 and 0.7, in particular approximately 0.5 and/or that the ratio of the outer diameter of a winding of the stator to the outer diameter of the iron return is between 0.6 and 0.9, in particular approximately 0.8.

15. A method for assembling a brushless motor, in particular according to claim 1, comprising at least the following method steps:
providing of a motor flange with an outer sleeve disposed thereon for delimiting the housing of the motor and an inner sleeve disposed on the motor flange in particular wherein a flange portion of the inner sleeve enters the motor flange,
at least partially filling of a stator chamber between inner sleeve and outer sleeve with a first potting compound,
disposing the stator windings and an iron return in the stator chamber, in particular on an outer circumference of the inner sleeve, in the, in particular not yet solified, first potting compound,
inserting the rotor together with the rotor bearing elements into a rotor chamber formed by the inner sleeve, so that a motor shaft portion of the rotor protrudes from the housing in a region of the motor flange,
disposing a flushing flange, in particular at least partially in the inner sleeve, and at least one centering flange, in particular between the inner sleeve and the outer sleeve,
potting of the housing on a second end face with a second potting compound.
